(19) United States
(12) Patent Application Publication
(10) Pub. No.: US 2008/0297667 A1
(43) Pub. Date: Dec. 4, 2008

(54) PROJECTION APPARATUS WITH DIRECT ATTACHMENT OF EXTERNAL STORAGE MEDIA

(75) Inventors: Sukesh Patel, Cupertino, CA (US); Manika Kaushal, San Jose, CA (US)

Correspondence Address: AMIN, TUROCY & CALVIN, LLP, 127 Public Square, 57th Floor, Key Tower, CLEVELAND, OH, 44114, US

(73) Assignee: CONCEPTTAPISTRY, LLC, Cupertino, CA (US)

(21) Appl. No.: 11/756,812

(22) Filed: Jun. 1, 2007

(51) Int. Cl. H04N 5/64

(52) U.S. Cl. 348/744; 348/E05.128

(57) ABSTRACT

The subject invention provides systems and methodologies for projecting data from storage media directly attached to a projector. In one embodiment, a projector unit is provided that comprises an input port attached to the projector unit that receives input data from storage media connected to the input port; an embedded computer within the projector unit that utilizes an operating system and has applications stored thereon operable to render input data received from the storage media connected to the input port as a video signal; at least one of a local display screen attached to the projector and a projection lens within the projector for displaying a video signal rendered by the embedded computer; and a control input device attached to the projector unit that facilitates the communication of control input to the projector unit.

### TECHNICAL FIELD

The subject invention relates generally projection devices, and more specifically to accessing information to be projected.

### BACKGROUND OF THE INVENTION

Traditional projectors and projection systems are capable of displaying an image on a display screen by projecting light from the projection system to the display screen. Currently available projectors and projection systems are designed to receive an image to be projected by a variety of means. For example, advances in technology now allow a projector to obtain an image to be projected via an external video signal. Often, this external video signal is communicated to the projector by a computing device such as a personal or laptop computer. In most such cases, the computer is connected to the projector with a serial or USB cable. The computer contains files to be projected as well as applications to render those files into a video signal usable by the projector. This type of traditional computer-projector system is widely used in the business and education fields because it provides an effective means of communication with an audience.

In many cases, an individual giving a presentation using a traditional computer-projector system is required to have the files to be presented on some form of external storage media. This is especially the case when the presenter has had no prior opportunity to access the projection system, such as when the presenter belongs to an external organization. Before the presentation, the presenter must attach the external storage media to the computer connected to the projector. The presenter then starts the presentation by executing an appropriate application on the computer that renders the files on the external storage media as a video signal and communicates the rendered video signal to the projector.

Often, preparing a conventional computer-projector system for a presentation is a time-consuming process. The computer and the projector must first be connected to one another. Typically, this requires running cables between the computer and the projector. Once the computer and the projector are connected, the presenter must then navigate through the operating system of the computer to find the appropriate application to render the files to be projected. If the presenter belongs to an external organization, he may be unfamiliar with particular system settings and applications on the computer used by the organization to which the computer belongs or even the operating system of the computer itself. Thus, the presenter will lose time, either by attempting to find the appropriate application himself despite his unfamiliarity with the system or by seeking assistance in finding the appropriate application from a member of the organization to which the system belongs.

Additionally, currently available computer-projector systems are often unnecessarily costly because an external, general purpose computer is required to interface with the projector in order to render the files to be projected as a video signal usable by the projector. Furthermore, because currently available computer-projector systems require an external computer to interface with the projector, such systems do not have a high degree of portability. Currently available computer-projector systems can be made more portable by interfacing a laptop computer or other portable computing device with the projector, but the portable computing device may not be compatible with the projector due to a conflict of screen resolutions, drivers, or some other attribute. If such a conflict exists, a less portable computer may be required to interface with the projector.

In view of at least the foregoing, there exists an unmet need in the art for a video projection system that reduces or eliminates the problems associated with an external computer interface.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention mitigates many of the problems associated with an external computer interface in a video projection system. In particular, the subject invention provides a system and/or methodology for projecting input data from external storage media that is directly attached to a projector. Further, the subject invention provides a system and/or methodology for user-friendly, graphical navigation of the contents of the external storage media directly attached to the projector. Benefits of the subject invention over traditional computer-projector systems include increased user efficiency and ease of use, reduced cost, and increased portability.

An aspect of the present invention provides for a projector system. The projector system includes an input component that receives input data from external storage media that is directly attached to the projector system, a rendering component that renders the input data as a video signal, and a projection component that projects the video signal onto a display area.

Another aspect of the present invention provides for a projector system that includes input, rendering, and projection components as stated above. Additionally, the projector system includes a configuration component that configures one or more properties of the projection component (e.g., brightness, contrast, position, etc.) and a control component that allows a user to interface with the rendering and configuration components and to supply control commands thereto.

In one particular example, the projection component is capable of displaying either a rendered video signal from the rendering component or a configuration display signal from the configuration component, as selected by an input select switch included in the control component. Further, the projection component is capable of displaying data on either a projected display or a local display, as selected by an output select switch included in the control component. Additionally and/or alternatively, a user can supply control commands to the rendering and/or configuration components via a control input device.

In another example, control commands are supplied to the projector system via a remote control component. The control commands are received by a control receiver component located within the projector and communicated to the rendering and/or configuration component by the control receiver component.

In another example, the projector system is employed in the context of a projector unit. The projector unit includes a low-cost embedded computer having an input port that allows external storage media to be directly connected to the projector unit as well as applications and file converters operable to render data from the external storage media as a video signal usable by the projector. Additionally, the projector unit includes optical configuration equipment, a local display and a projection lens for displaying a video signal, speaker capability for audio, input and output select switches, and a joystick-like input device. The projector unit also optionally can include a keyboard port for further control input capability.

In yet another example, the rendering component facilitates the rendering of input data from external storage media by supplying a user-friendly, graphical interface. A user can navigate through the system by moving a cursor located on the interface with a control input device. The interface can contain representations of files and folders within the external storage media as well as navigation buttons to facilitate navigation between folders. Additionally, the interface can display scroll bars at one or more sides of the screen to alert the user that the contents of the folder currently being viewed exceed the bounds of the interface display area.

In still another example, the projector system includes a remote control unit. The remote control unit can include optical configuration inputs, input and output select switches, and a control input device.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the subject invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a high-level block diagram of a projector system in accordance with an aspect of the present invention.

FIG. 2 is a block diagram of a projector system in accordance with an aspect of the present invention.

FIG. 3 is a block diagram of a projector system in accordance with an aspect of the present invention.

FIG. 4 is a block diagram of a projector system that includes a remote control component in accordance with an aspect of the present invention.

FIG. 5 illustrates a traditional projector system having an external computer interface.

FIG. 6 illustrates an exemplary projector system in accordance with an aspect of the present invention.

FIG. 7 is a diagram of an exemplary projector unit in accordance with an aspect of the present invention.

FIG. 8 is a diagram of an exemplary user interface for a projector system in accordance with an aspect of the present invention.

FIG. 9 illustrates an exemplary remote control unit for use with a projector system in accordance with an aspect of the present invention.

FIG. 10 is a flowchart of a method of projecting data in accordance with an aspect of the present invention.

FIG. 11 is a flowchart of a method of projecting data in accordance with an aspect of the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

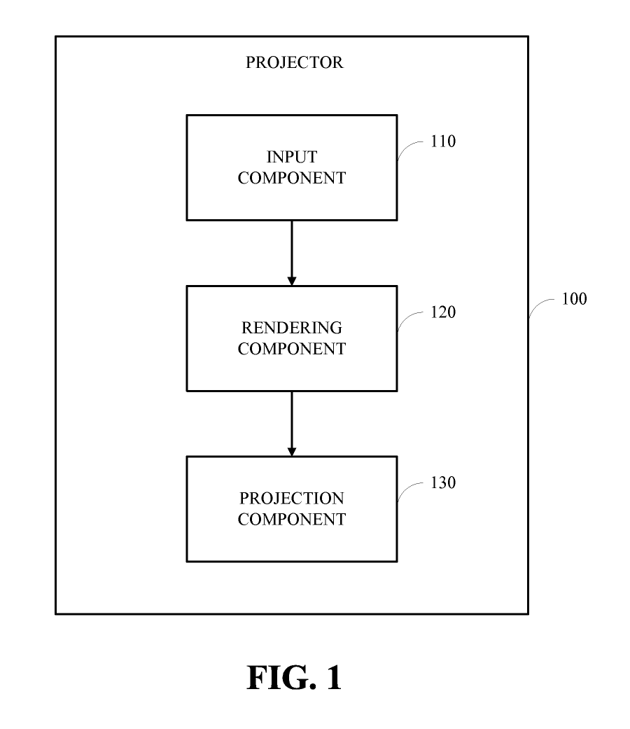

Referring now to the drawings, FIG. 1 illustrates a high-level overview of a projector system 100 in accordance with an aspect of the present invention. The projector system 100 includes an input component 110 that receives input data from external storage media that is directly attached to the projector system 100, a rendering component 120 that renders the input data received by the input component 110 into a video signal, and a projection component 130 that facilitates the display of the video signal rendered by the rendering component 120. In one embodiment of the present invention, the projector system 100 and the components included therein are housed by a single structure.

In one example, external storage media containing input data in the form of computer files is directly connected to the input component 110 via an input port. The input port can be, for example, a universal serial bus (USB) port, a USB2 port, a FireWire port, a SCSI interface port, an Ethernet port, or any other suitable type of input port. Further, the external storage media can be a thumb drive, an external disk drive, a flash memory card, a memory stick, or any other suitable type of external storage media. It is to be appreciated that any suitable input port and any suitable form of external storage media are intended to fall within the scope of the hereto appended claims.

In another example, the rendering component 120 employs an embedded computer that renders the files received by the input component 110 as a video signal usable by the projection component 130. The embedded computer renders the files received by the input component 110 by utilizing a common set of application readers and/or file format converters. In accordance with one embodiment, additional application readers and/or file format converters can be added to the rendering component 120 by supplying external storage media containing installation software for the additional application readers and/or file format converters to the input component 110.

In another example, the projection component 130 includes optical hardware necessary for projecting a video signal rendered by the rendering component 120 onto an external projector display area (e.g., a wall mounted projection screen). Additionally and/or alternatively, the projection component can display a video signal on a local display located within the projector system 100. Further, in accordance with alternative embodiments of the present invention, the projection component 130 can also provide audio output via local speakers located within the projector system 100 and/or external speakers connected to an audio output port located within the projector system 100.

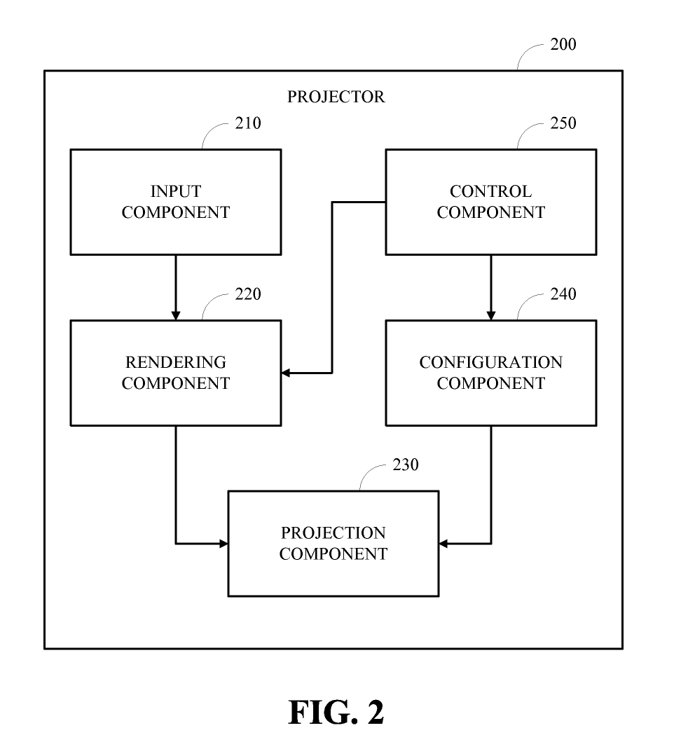

Turning to FIG. 2, a projector system 200 in accordance with an aspect of the present invention is illustrated. The projector system 200 includes an input component 210 that receives input data from external storage media that is directly attached to the projector system 200, a rendering component 220 that renders the input data received by the input component 210 into a video signal, a projection component 230 that facilitates the display of the video signal rendered by the rendering component 220, a configuration component 240 that configures one or more properties of the projection component 230, and a control component 250 that allows a user to provide control input to the rendering component 220 and the configuration component 240. In one embodiment of the present invention, the projector system 200 and the components included therein are housed by a single structure.

In one example, the rendering component 220 provides a graphical user interface that allows a user to navigate through the input data supplied by the external storage media connected to the input component 210. The graphical user interface is rendered as a video signal by the rendering component 220 and sent to the projection component 230 for display. The user can navigate through this interface by supplying control input to the control component 250 via a joystick, keyboard, or other suitable control input device.

In another example, the configuration component 240 provides a graphical menu to aid a user in setting up, configuring, and troubleshooting the projection component 230. It should be appreciated that the configuration component 240 can also be used to configure components other than the projection component 230. For example, the configuration component 240 can be used to configure the properties of the type of input device (e.g., joystick, keyboard, etc.) connected to the control component 250. The configuration menu is sent to the projection component 250 for display, and upon being displayed the user can navigate through the configuration menu by supplying control input to the control component 250. In another example, the control component 250 allows a user to select either the rendered video output of the rendering component 220 or the configuration menu from the configuration component 240 for display by the projection component 230.

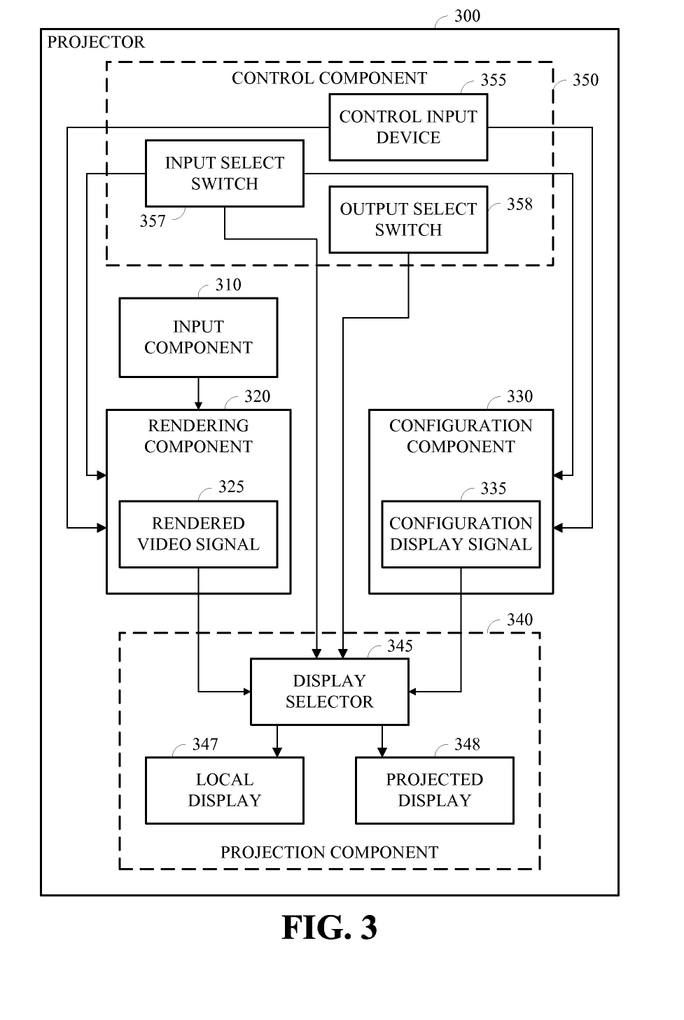

Referring now to FIG. 3, a projector system 300 in accordance with an aspect of the present invention is illustrated. The projector system 300 includes an input component 310 that receives input data from external storage media that is directly attached to the projector system 300. The projector system 300 further includes a rendering component 320 that receives input data from the input component 310. The rendering component renders the input data as a rendered video signal 325 and communicates the rendered video signal 325 to the projection component 340. In one embodiment, the rendering component 320 provides a graphical user interface to facilitate navigation through the input data. This graphical user interface is rendered as part of the rendered video signal 325 and sent to the projection component 340 for display. Once displayed, the user can navigate through the graphical user interface by utilizing a control input device 355 within the control component 350.

The projector system 300 further includes a configuration component 330 that facilitates the setup, configuration, and troubleshooting of the projection component 340. In one embodiment, the configuration component can adjust properties of optical hardware located within the projection component 340, such as lamp brightness, color balance, location and focus of optical lenses, and other such properties. Additionally, the configuration component 330 can adjust audio output properties from the projection component 340 such as volume, speaker balance, treble/bass levels, and other such properties. In another embodiment, the configuration component 330 provides a graphical configuration menu to facilitate user configuration of the projection component 340. This graphical configuration menu is sent to the projection component 340 for display via a configuration display signal 335. Once displayed, the user can navigate through the configuration menu by utilizing a control input device 355 within the control component 350.

A projection component 340 within the projector system 300 displays data received by the rendering component 320 and the configuration component 330. In accordance with one embodiment of the present invention, the projection component includes a display selector 345, a local display 347, and a projected display 348. The local display 347 is physically attached to the projector system 300 and can be a liquid crystal device, cathode ray tube (CRT), field emission device (FED, also called flat panel CRT), or any other suitable type of display device. The projected display 348 includes optical hardware, such as optical lenses and a projector lamp, for projecting a video signal onto a projector display area. In one example of the present invention, the local display 347 and/or the projected display 348 can additionally provide audio output through local speakers physically attached to the projector system 300 and/or through an audio output port that provides an interface for external speakers.

In one example, the display selector 345 receives the rendered video signal 325 from the rendering component 320 and the configuration display signal 335 from the configuration component 330. Additionally, the display selector 345 receives an input select signal from an input select switch 357 and an output select signal from an output select switch 358, both of which are located within a control component 350. The display selector 345 selects a signal to display from the rendered video signal 325 and the configuration display signal 335 based at least in part upon the input select signal from the input select switch 357. The display selector will then display the selected signal at one or both of the local display 347 and the projected display 348 based at least in part upon the output select signal from the output select switch 358.

A control component 350 within the projector system 300 provides user control input to the rendering component 320, the configuration component 330, and the display selector 345 within the projection component 340. In accordance with one embodiment of the present invention, the control component 350 includes a control input device 355, an input select switch 357, and an output select switch 358. The control input device 355 allows a user to provide control input to the rendering component 320 or the configuration component 330. In accordance with various aspects of the present invention, the control input device 355 can be a joystick, mouse, keyboard, touch pad, trackball, or any other suitable device. Further, the control input device 355 can either be a local device physically attached to the projector system 300 or an external device connected to the projector system via a control input port (not shown). In one example, the control input device 355 allows a user to enter directional movement input (e.g., up, down, left, and right). Further, in one example, the control input device 355 can be engaged to simulate “single-click” and “double-click” actions. In the non-limiting example of a joystick-like control input device 355, the control input device 355 can be engaged by depressing the device, pressing a button located on or near the device, or any other suitable method for engaging the device.

In one example, the input select switch 357 allows a user to select a signal to display at the projection component 340 from a rendered video signal 325 and a configuration display signal 335. Further, the output select switch 358 allows a user to select one or both display(s) to be used by the projection component 340 from a local display 347 and/or a projected display 348. In another example, the input select switch 357 can be used in conjunction with the control input device 355 such that the control input device 355 supplies control input selectively to only the component selected by the input select switch 357 from the rendering component 320 and the configuration component 330.

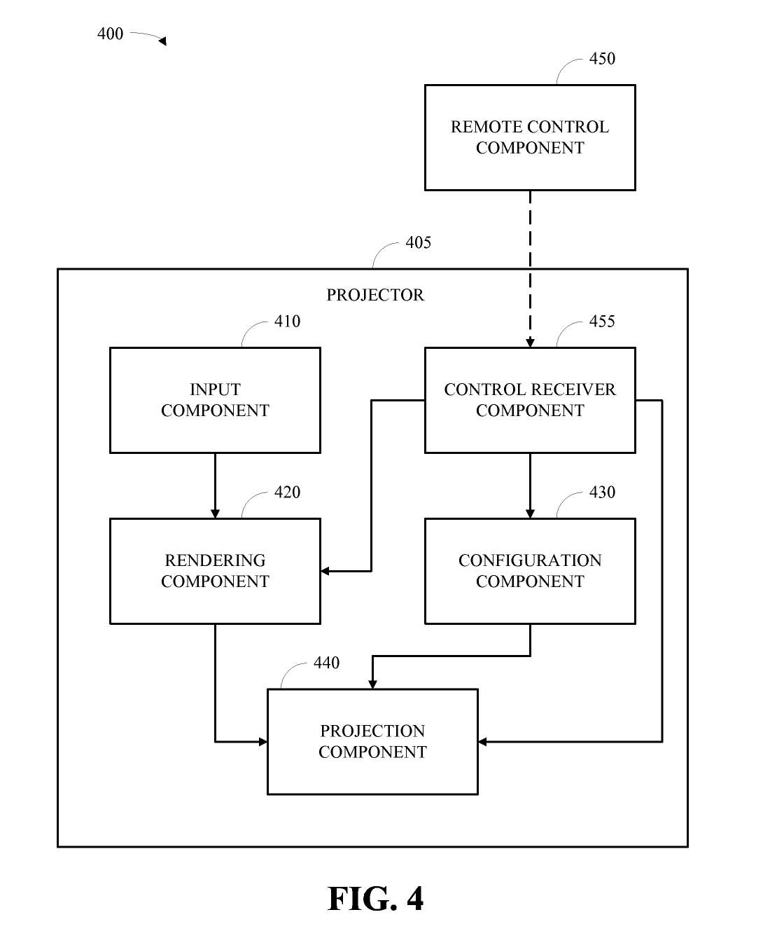

Turning to FIG. 4, a projector system 400 that includes a remote control component 450 in accordance with an aspect of the present invention is illustrated. The projector system 400 includes a projector unit 405 that contains an input component 410 that receives input data from external storage media directly attached to the projector unit 405, a rendering component 420 that renders the input data received by the input component 410 as a video signal, a projection component 440 that displays the video signal rendered by the rendering component 420, and a configuration component 430 that facilitates configuration of the projection component 440. The projector system 400 further includes a remote control component 450 that is external to the projector unit 405. The remote control component 450 allows a user to provide control input to a control receiver component 455 at the projector unit 405, which in turn communicates the control input to other components within the projector unit 405. For example, the control receiver component 455 can communicate control input received by the remote control component 450 to the rendering component 420, the configuration component 330, and/or the projection component 440.

In one example, the remote control component 450 is wirelessly connected to the control receiver component 455. The wireless connection can be, for example, a direct infrared (IR) connection, a direct radio frequency (RF) connection, a wireless network connection employing one of the IEEE 802.11x set of standards or any other suitable standard, or any other suitable wireless connection. It is to be appreciated that any suitable type of wireless connection is intended to fall within the scope of the hereto appended claims. In another example, the remote control component 450 includes a control input device to facilitate the supply of control input to the projector unit 405. The control input device can be, for example, a joystick, keyboard, or other suitable control input device. Further, the control input device can be physically attached to the remote control component 350 or connected to the remote control component 350 via a control input port.

In another example, the remote control component 450 includes an input select switch that selects a video signal among those provided by various components within the projector unit 405 to be displayed by the projection component 440. Additionally and/or alternatively, the input select switch can also be used in conjunction with a control input device to instruct the control receiver component 455 to provide control input selectively to one or more components within the projector unit 405. In yet another example, the remote control component 450 includes an output select switch that selects one or more displays to be used by the projection component 440 to display a rendered video signal.

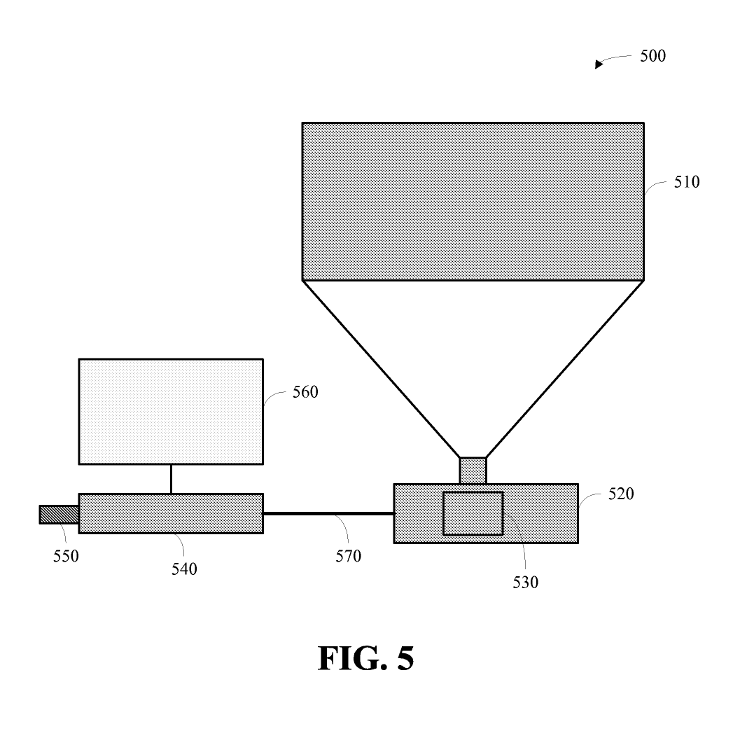

Turning now to FIGS. 5-9, diagrams are provided to illustrate various embodiments of the present invention. For the avoidance of doubt, the subject matter of the present invention is not limited by such examples. In addition, the embodiments illustrated herein are not necessarily to be construed as preferred or advantageous over other aspects or designs, nor are they meant to preclude equivalent structures and techniques known to those of ordinary skill in the art. Furthermore, it is to be appreciated that the various drawings are not drawn to scale from one figure to another nor inside a given figure, and in particular that the size of the components are arbitrarily drawn for facilitating the reading of the drawings.

Turning briefly to FIG. 5, a traditional projector system 500 having an external computer interface is illustrated. The traditional projector system 500 includes a projector 520 with a small user interface display screen 530 that can project an image onto a projection screen 510. The projector receives an image to display from an external computer 540 connected via a cable 570. The computer 540 can include traditional input devices (not shown) such as a mouse and/or keyboard. Additionally, the computer 540 has a port that can be used to attach an external storage device 550. The computer is also equipped with a local display output device 560.

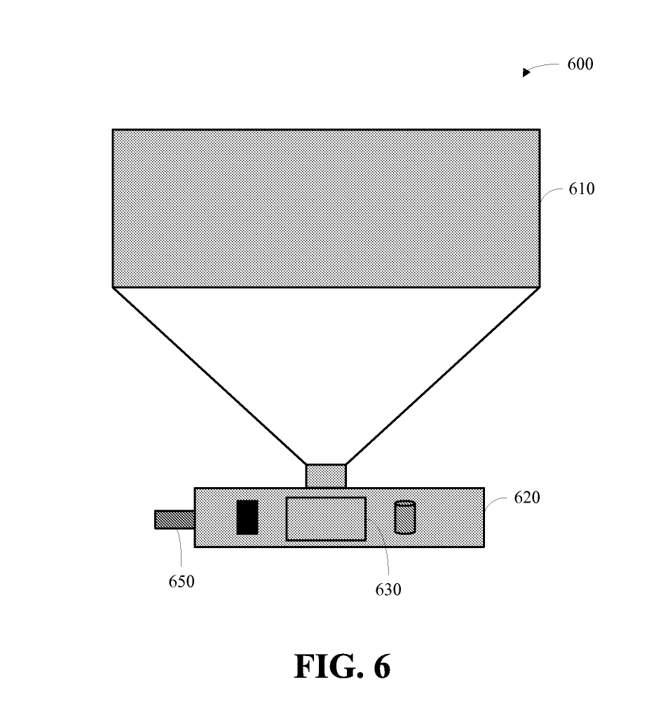

Referring now to FIG. 6, an exemplary projector system 600 in accordance with an aspect of the present invention is illustrated. The projector system 600 includes a projector 620 that can project an image onto a projection screen 610 and/or display an image on a display device 630 on the projector 620. In contrast to the traditional projector system 500, the projector system 600 does not require an external computer or a communication cable from an external computer to the projector 620 to render a video signal. The projector 620 provides an input port that allows an external storage device 650 to be directly attached to the projector 620. The input port can be, for example, a universal serial bus (USB) port, a USB2 port, a FireWire port, a SCSI interface port, an Ethernet port, or any other suitable type of input port. Further, the external storage media can be a thumb drive, an external disk drive, a flash memory card, a memory stick, or any other suitable type of external storage media.

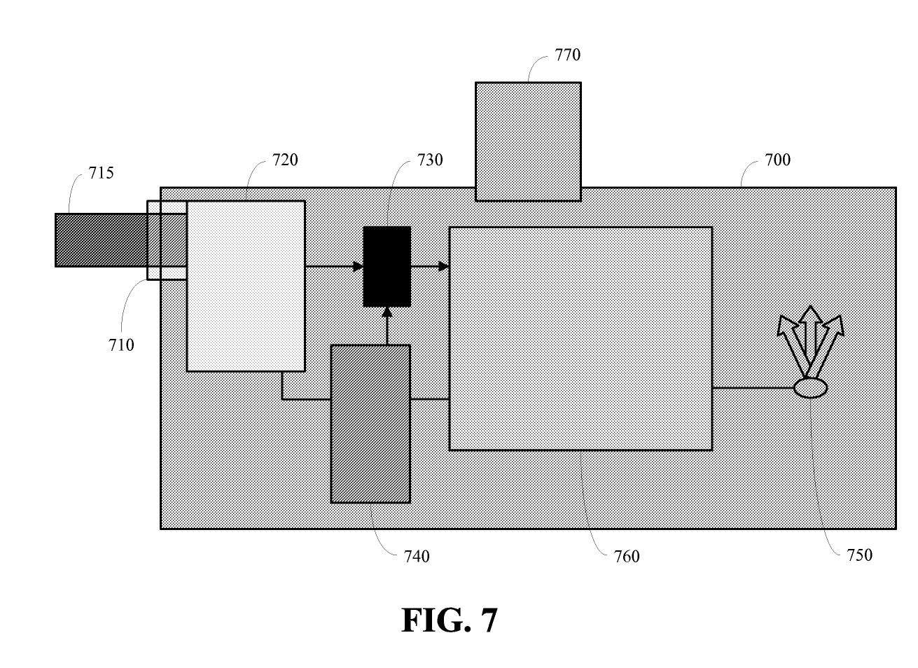

Turning to FIG. 7, an exemplary projector unit 700 in accordance with an aspect of the present invention is illustrated. The projector unit includes an input port 710 that allows an external storage device 715 to be directly attached to the projector 700. In accordance with one aspect of the present invention, the input port 710 is connected to a low-cost embedded computer 720.

In one example, the embedded computer 720 runs a simple operating system and is preinstalled with a set of common application readers for word processor files, presentation files, spreadsheet files, and/or other suitable types of files. In accordance with one aspect of the present invention, newer versions of application readers can be installed onto the embedded computer 720 by running new versions of the install software from an external storage device 715 via the input port 710.

In another example, the embedded computer 720 is preinstalled with a set of file format conversion utilities that allow conversion from a particular source format to a format that can be rendered by an application reader installed on the embedded computer 720. As a specific, non-limiting example of alternative aspects of the present invention, a user may have a document generated in a first word processing format, but the embedded computer 720 may have a reader only for a second word processing format. The embedded computer 720 can overcome such issues in at least two distinct ways. First, an application corresponding to the first word processing format or a reader for said first format can be installed on the embedded computer 720 from external storage media 715 connected to the input port 710. Alternatively, a file format converter can be installed that facilitates conversion from the first word processing format to the second word processing format. Thus, whenever a document that utilizes the first format is selected, the embedded computer 720 automatically converts it to the second format so it can be viewed by application reader software for the second format on the embedded computer 720. In accordance with an additional aspect of the present invention, if multiple file format converters are present on the embedded computer 720 that are operable to convert the same source format to different output formats, the embedded computer 720 can prompt the user to select a converter to be utilized.

In another example, the embedded computer 720 is housed on a single motherboard with support for input and output through an input/output bus. The input port 710 is connected to the embedded computer 720 via the input/output bus and an input device 750 is connected to the input/output bus via a switch component 730. The input device 750 can, for example, allow a user to enter control input to facilitate navigation through a graphical user interface provided by the embedded computer 720. Additionally, display output connectors from the input/output bus of the embedded computer 720 can also be connected to the switch component 730.

In accordance with one aspect of the present invention, a simple gesture-based input device 750 is additionally employed by the projector 700. In one example, the input device 750 is designed to look and perform like a joystick. The user can move the input device 750 up, down, left, and right to provide directional control input. Additionally, input device 750 can be engaged to provide “single click” and/or “double click” actions. In alternative examples, the input device 750 can be engaged by pressing the input device downward or by pressing a button located on or near the input device 750. The input device 750 can be connected to the embedded computer 720 and to optical hardware 740 through a switch component 730. Additionally and/or alternatively, the projector 700 is equipped with an input port (not shown) to allow an external input device, such as a keyboard, mouse, or other appropriate device, to be connected to the projector 700.

In accordance with another aspect of the present invention, the projector 700 is equipped with optical hardware 740. In various examples of the present invention, the optical hardware 740 can be used for optical projection, the setup and configuration of an optical projection system, the adjustment of optical lenses, power for a projector lamp, and other appropriate uses. In one example, the optical hardware 740 provides a display for setup, configuration, and troubleshooting information. This display output is communicated to the switch component 730 for display by the projector 700. In another example, the input device 750 can allow a user to enter control input to facilitate navigation through the display generated by the optical hardware 740.

In accordance with another aspect of the present invention, the projector 700 includes a display screen 760. In one example, the display screen 760 is physically attached to the projector 700. The display screen 760 can be a liquid crystal display (LCD), cathode ray tube (CRT), field emission device (FED, also called flat panel CRT), or any other suitable type of display device. In one example, the switch component 730 is used to select the input source for display on the display screen 760. When the switch component 730 is set to select the embedded computer 720, the display output of the computer 720 is displayed on the display screen 760 and control input from the input device 750 is routed to the embedded computer 720. When the switch 730 is set to select the optical hardware 740, the output of the optical hardware 740 is sent to the display screen 760 and control input from the input device 750 is routed to the optical hardware 740. In another example, the switch component 730 is used to select whether a selected data signal is displayed on the display screen 760, projected onto a projection screen (not shown) via a projection lens 770, or both.

In another example, in addition to providing video output via the display screen 760 and/or the projection lens 770, the projector 700 can also provide audio output. In accordance with alternative embodiments, the projector 700 includes speakers (not shown) that are mounted to the projector 700 and/or an audio output port (not shown) to which external speakers can be connected. In one example, the switch component 730 is used to select whether audio output is provided by locally mounted speakers, external speakers, or both.

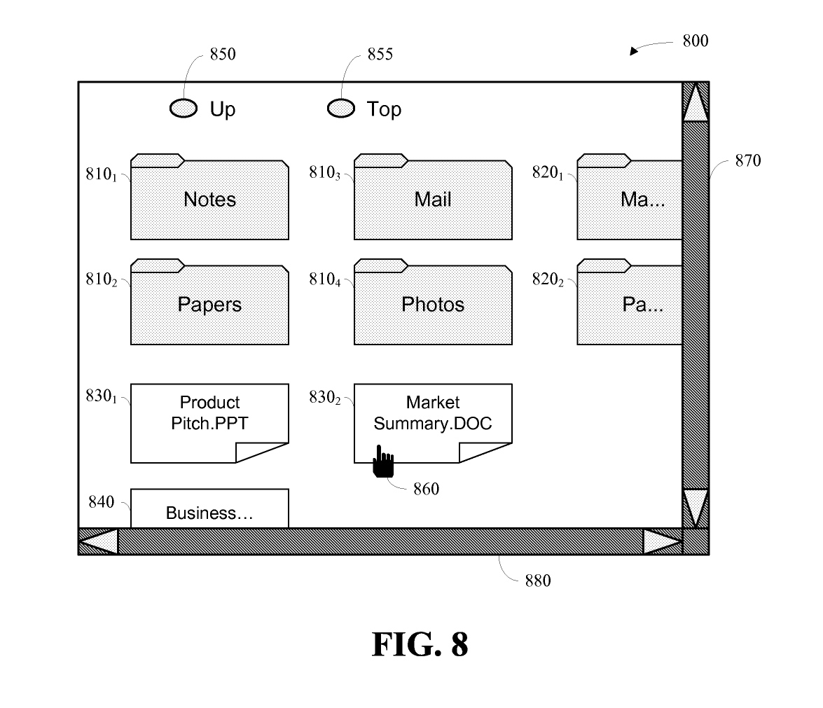

Referring now to FIG. 8, an exemplary user interface 800 for a projector system in accordance with an aspect of the present invention is illustrated. Because the contents of an external storage device (e.g., connected to an input component 110) may not be capable of being completely displayed on a single screen (e.g., of a local display 760), a user-friendly graphical interface is provided by the projector system (e.g., by a rendering component 120). In one example, a user can navigate through the user interface 800 by using a control input device (e.g., control input device 355).

In accordance with one aspect of the present invention, the user interface 800 initially displays the folders 810 and 820 and files 830 and 840 contained in the topmost (i.e., root) folder of an external storage device. In one example, different icons can be used to distinguish folders 810 and 820 from individual files 830 and 840 within the file system. For example, folders can have a “folder” icon while individual files can have a “document” icon. Additionally, different types of individual files 830 and 840 may also have distinct icons. For example, files of a first type may be displayed with an icon that is different from the icon used for files of a second type. In another example, the folders 810 and 820 and files 830 and 840 are arranged in a grid-like structure consisting of rows and columns.

In one example, the user interface 800 contains a cursor 860. The cursor 860 can be moved in various directions within the user interface 800 by, for example, moving a control input device (e.g., control input device 335). In one specific, non-limiting example, moving a control input device causes the cursor 860 to move in the direction of the movement of the control input device. In alternative embodiments of the present invention, the cursor 860 can respond to a movement of a control input device either by moving a predetermined distance within the user interface 800 (i.e., a predetermined number of pixels) or by moving from one icon or navigation button within the user interface 800 to the next adjacent icon or navigation button in the direction of the movement of the control input device.

In accordance with another example of the present invention, the user interface 800 includes navigation buttons. These navigation buttons can include, for example, an “Up” button 850 and a “Top” button 855. In one example, when the cursor 860 is located over an “Up” button 850 and the user performs a “single click” action with a control input device, the display contents of the user interface 800 will be replaced with the contents of the parent folder of the folder being currently displayed. In another example, if the current folder has no parent folder (i.e., the current folder is the root or topmost folder), the display remains unchanged. Additionally and/or alternatively, when the cursor 860 is located over a “Top” button 855 and a “single click” gesture is performed, the display contents of the user interface 800 are replaced with the contents of the root or topmost folder. As with the “Up” button 850, if the topmost folder of the external storage device is currently being displayed, the display will remain unchanged.

In one example, when the cursor 860 is located over a folder 810 or 820 and the user performs a “single click” gesture, the display contents of the user interface 800 are replaced with the contents of the folder under the cursor. In this manner, the user can navigate up and down the folder hierarchy of an external storage device. In another example, if the cursor is located over a file 830 or 840 and the user performs a “single click” action, the corresponding file is prepared for rendering by the projector system (e.g., by a rendering component 120 and/or embedded computer 720).

In accordance with one aspect of the present invention, the user interface 800 displays scroll bars 870 and 880 when the contents of a folder exceed the size capability of the user interface 800. The scroll bars 870 and 880 give a visual cue to the user that additional content can be accessed within the user interface 800 by moving the cursor 860 past the edges of the user interface 800. In one example, the user interface 800 additionally displays partial folders 820 and partial files 840 when the size of the user interface 800 cannot accommodate the entire folders and/or files. The partial folders 820 and partial files 840 give an additional visual cue to the user that the cursor 860 can be moved past the edges of the user interface 800. In these examples, when the cursor 860 is moved past an edge of the user interface 800, the contents of the user interface 800 are moved in the opposite direction. With reference to FIG. 8, it should be appreciated that moving the cursor 860 past the right edge of the user interface 800 would cause the contents of the user interface 800 to move to the right, thereby causing the partial folders 820 to be completely displayed. Similarly, moving the cursor 860 past the bottom edge of the user interface 800 would cause the contents of the user interface 800 to move up, thereby causing the partial file 840 to be completely displayed.

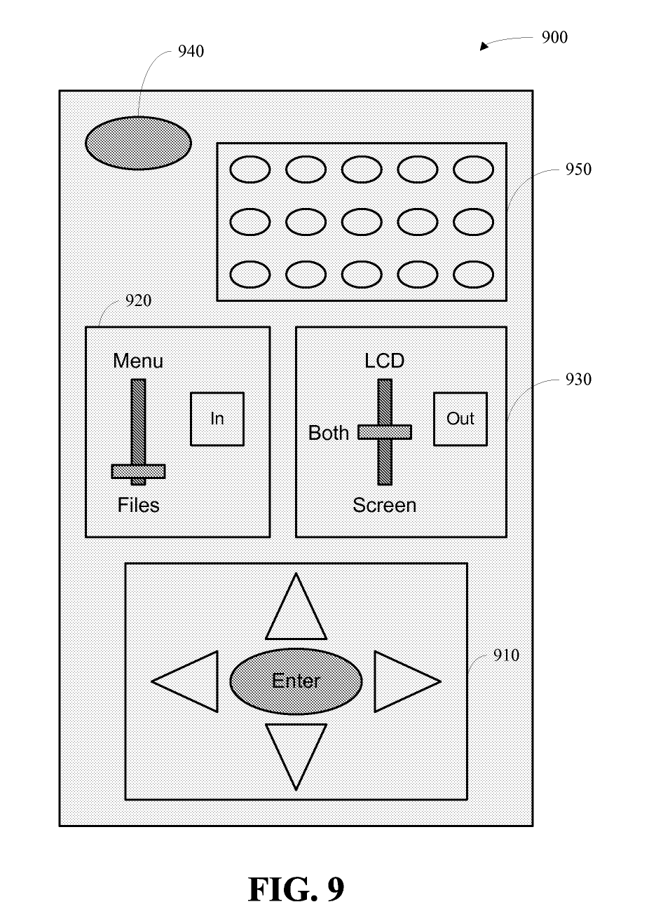

Turning now to FIG. 9, an exemplary remote control unit 900 for use with a projector system in accordance with an aspect of the present invention is illustrated. In a similar manner to the remote control component 450, the remote control unit 900 allows a user to provide control input to a projector unit (e.g., a projector unit with a control receiver component 455). The remote control unit 900 can be used in addition to or in place of control devices located on a projector unit. In one example, the remote control unit 900 additionally includes a power button 940 and a set of control buttons 950 that can adjust common control elements traditionally utilized by projector systems, such as brightness, color balance, and/or other appropriate control elements.

In one example, the remote control unit 900 includes a control input device 910. As a specific, non-limiting example, the control input device 910 can be made up of four arrow buttons pointing up, down, left, and right, as well as an enter button. Pressing an arrow button located on the control input device 910 can, for example, move an on-screen cursor in the direction of the arrow. In the specific, non-limiting example of a user interface 800, the arrow buttons can move the cursor 860 between files, folders, or navigation buttons along the same row or the same column. Alternatively, the arrow buttons can move the cursor 860 a predetermined distance within the user interface 800 in a similar manner to a local control input device. Additionally, pressing the enter button on the control input device 910 can, for example, have the same effect as a “single click” gesture performed with a local input device.

In another example, the remote control unit 900 includes an input selection switch 920 and an output selection switch 930. The input selection switch 920 can, for example, select an output signal to display from a series of output signals generated by various components of the projector unit (e.g., an embedded computer 720 and optical hardware 740). Thus, in one example, the input select switch 920 has substantially similar functionality to the input select switch 357. In a further, non-limiting example, the input selection switch 920 has a “Files” setting and a “Menu” setting. When the input selection switch 920 switch is set to “Files,” a rendered video signal (e.g., rendered video signal 325 produced by a rendering component 320) is sent to the projector unit (e.g., to a projection component 340) and all control inputs (e.g., control inputs from the control input device 910 within the control unit 900 and the local control input device 355) are routed to the portion of the projector unit responsible for rendering the video signal (e.g., the rendering component 320). Similarly, when the input selection switch 920 is set to “Menu,” a configuration display signal (e.g., configuration display signal 335 produced by a configuration component 330) is sent to the projector unit and all control inputs are routed to the portion of the projector unit responsible for configuring the projector (e.g., the configuration component 330).

The output selection switch 930 can, for example, select a display area (e.g., between a local display 347 and a projected display 348) to display the signal selected by the input selection switch 920. Thus, in one example, the output select switch 930 has substantially similar functionality to the input select switch 358. In a further, non-limiting example, the output selection switch 930 can have a “LCD” setting to route selected display output to a local LCD display (e.g., local display 347), a “Screen” setting to route the selected display output to a projection lens for display on a projection screen (e.g., by a projected display 348), and a “Both” setting for routing the selected display output to both the local LCD display and the projection lens.

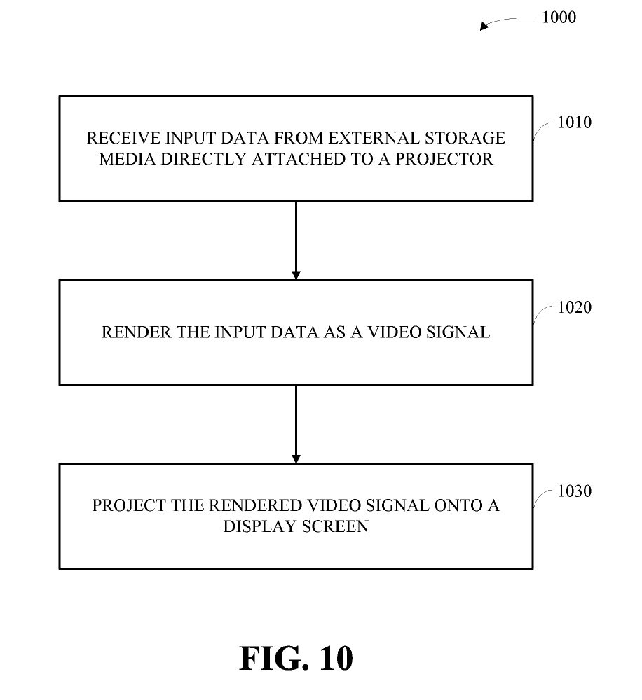

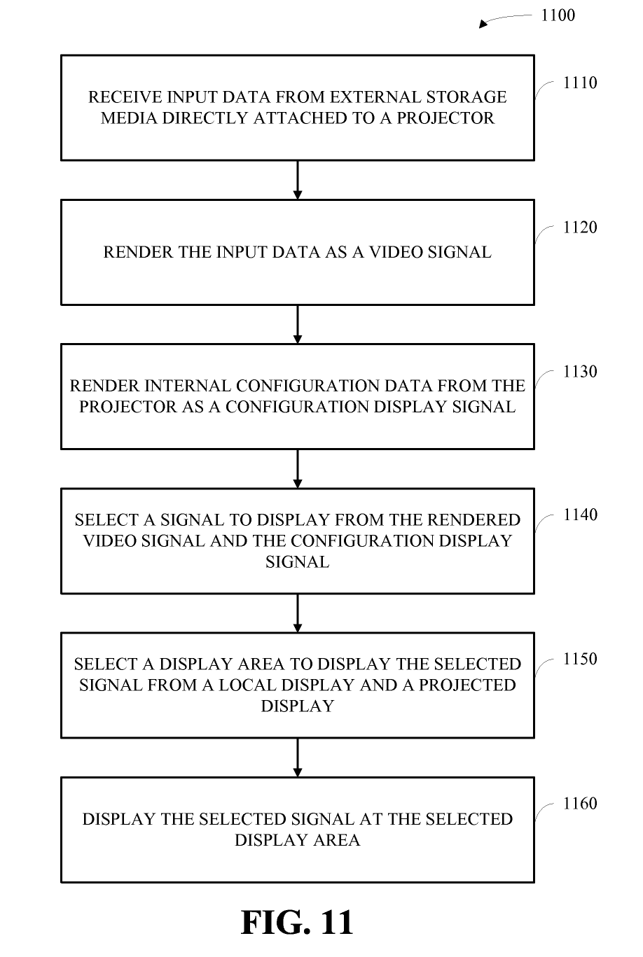

Turning briefly to FIGS. 10 and 11, methodologies that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

Referring to FIG. 10, a method of projecting data in accordance with an aspect of the present invention is illustrated. At 1010, input data is received from external storage media directly attached to a projector (e.g., by an input component 110). At 1020, the input data is rendered as a video signal (e.g., by a rendering component 120). At 1030, the rendered video signal is projected onto a display screen (e.g., by a projection component 130).

Next, referring to FIG. 11, a method of projecting data in accordance with an aspect of the present invention is illustrated. At 1110, input data is received from external storage media directly attached to a projector (e.g., by an input component 310). At 1120, the input data is rendered as a video signal (e.g., by a rendering component 320 producing a rendered video signal 325). At 1130, internal configuration data from the projector is rendered as a configuration display signal (e.g., by a configuration component 330 producing a configuration display signal 335). At 1140, a signal is selected for display from the rendered video signal and the configuration display signal (e.g., by an input select switch 357 within a control component 350). At 1150, a display area is selected for the display of the selected signal from a local display and a projected display (e.g., by an output select switch 358 within a control component 350, selecting from a local display 347 and a projected display 348 within a projection component 340). At 1160, the selected signal is displayed at the selected display area (e.g., by a projection component 340).

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A projector unit, comprising:
an input port attached to the projector unit that receives input data from storage media connected to the input port;
an embedded computer within the projector unit that utilizes an operating system and has applications stored thereon that render input data received from the storage media connected to the input port as a video signal;
at least one of a local display screen attached to the projector and a projection lens within the projector for displaying the video signal; and
a control input device attached to the projector unit that facilitates the communication of control input to the projector unit.

2. The projector unit of claim 1, wherein the input port is a USB-2 port.

3. The projector unit of claim 1, further comprising speaker output for playing audio provided by the video signal rendered by the embedded computer.

4. The projector unit of claim 1, further comprising optical hardware that provides a display for information necessary for the setup and configuration of the projector unit, wherein the control input device facilitates navigation through the display provided by the optical hardware.

5. The projector unit of claim 4, further comprising an input select switch that facilitates the selection of a signal for display from the video signal rendered by the embedded computer and the display provided by the optical hardware, wherein selecting the video signal rendered by the embedded computer causes the control input device to provide control input only to the embedded computer and selecting the display provided by the optical hardware causes the control input device to provide control input only to the optical hardware.

6. The projector unit of claim 1, further comprising an output select switch that allows a user to select an output source on which the video signal is to be displayed from a local display screen, a projection lens, or both the local display screen and the projection lens.

7. The projector unit of claim 1, wherein the embedded computer provides a graphical file system navigation interface for navigating through the contents of storage media connected to the input port, the interface comprises icons corresponding to the contents of a folder stored on the storage media.

8. The projector unit of claim 7, wherein the interface displays icons of a first icon type for files stored on the storage media and icons of a second icon type for folders stored on the storage media.

9. The projector unit of claim 7, wherein the interface further comprises navigation buttons that facilitate navigation through folders stored on the storage media.

10. The projector unit of claim 7, wherein the interface further comprises a cursor that moves and selects items within the interface based at least in part on input provided by the control input device.

11. The projector unit of claim 7, wherein the interface displays a scroll bar at one or more edges of the interface when the contents of a folder being displayed by the interface exceed the size of the interface, and the interface facilitates viewing of additional folder contents located beyond the one or more edges of the interface when one or more scroll bars are displayed.

12. The projector unit of claim 7, the projector unit further comprises a remote control unit that facilitates navigation through the interface, the remote control unit comprises at least four direction buttons that provide directional input and an enter button that provides selection input.

13. The projector unit of claim 12, wherein the remote control unit further comprises:
an input select switch that allows a user to select a signal for display from the video signal rendered by the embedded computer and a configuration display provided by optical hardware; and
an output select switch that allows a user to select an output source for display from a local display screen, a projection lens, or both the local display screen and the projection lens.

14. The projector unit of claim 1, wherein the control input device is a joystick and can be moved to provide directional input and engaged by one or more of pressing down on the control input device or pressing a button located on the control input device to provide selection input.

15. The projector unit of claim 1, further comprising a port that facilitates the connection of a keyboard.

16. The projector unit of claim 1, wherein the local display screen is a liquid crystal display.

17. The projector unit of claim 1, wherein the embedded computer further has one or more file format converters installed thereon that convert a file obtained from storage media connected to the input port from a first format to a second format to allow the file to be rendered by an application stored on the embedded computer that renders files of the second format.

18. A method of projecting data, comprising:
receiving input data from storage media directly attached to a projector;
rendering a video signal from the input data using an embedded computer;
receiving a configuration display signal from optical hardware; and
displaying at least one of the video signal and the configuration display signal.

19. The method of claim 18, further comprising the acts of:
selecting a signal to display from the video signal and the configuration display signal; and
selecting an area to display the selected signal from a local display and a projection display;
wherein the displaying includes displaying the selected signal at the selected display area.

20. A projector unit, comprising:
means for receiving data from storage media directly attached to the projector unit;
means for rendering the data as a video signal; and
means for displaying the rendered video signal on at least one of a local display screen and a projection screen.
